(19) United States
(12) Patent Application Publication
(10) Pub. No.: US 2022/0221271 A1
(43) Pub. Date: Jul. 14, 2022

(54) WHEEL ALIGNMENT MEASUREMENT SYSTEM AND METHOD

(71) Applicant: BPG Sales and Technology Investments, LLC, Ada, MI (US)

(72) Inventor: David M. DeBoer, Grand Rapids, MI (US)

(21) Appl. No.: 17/572,689

(22) Filed: Jan. 11, 2022

Related U.S. Application Data
(60) Provisional application No. 63/135,882, filed on Jan. 11, 2021.

(51) Int. Cl. G01B 11/27

(52) U.S. Cl. CPC G01B 11/272; G06K 7/1417

(57) ABSTRACT

A system for determining alignment characteristics of a wheel assembly of a vehicle includes one or more optical gauges that are selectively attached to a wheel assembly, with the optical gauge including a mounting base having an underside that is affixed to the wheel assembly and including a gauge piece comprising a known dimension. The system further includes a light projector that projects light onto the optical gauge when attached to the wheel assembly, a digital imager, and a controller. The digital imager is configured to image light from the light projector that is reflected from the optical gauge, and the controller is configured to calculate a distance from the optical gauge based on the imaged light that is reflected from the optical gauge and the known dimension of the gauge piece. The mounting base may be a tape that is adhesively affixed to the wheel assembly.

The present application claims priority of U.S. provisional application Ser. No. 63/135,882 filed Jan. 11, 2021, which is hereby incorporated herein by reference in its entirety

### BACKGROUND OF THE INVENTION

The present invention is directed to a wheel alignment measurement system and method, and in particular to a system and method in which an optical gauge of known dimensions is affixed to a wheel assembly and imaged by a camera.

In the automotive industry, proper vehicle quality requires measurement and adjustment of wheel alignment settings, both during manufacture and subsequently during the useful life of the vehicle. Proper positioning and alignment of vehicle wheels, and especially steerable wheels such as the front wheels of a vehicle, requires the setting of toe, camber angle, and caster angle. Toe is the angle between the vehicle's longitudinal axis and a plane through the center of the wheel/tire and affects the straight-ahead running of the vehicle as well as steering. Camber angle is the inclination of the wheel axis toward the road surface in a vertical plane and is negative when the top of the wheel is inclined toward the center of the vehicle. Caster angle is the tilt of the steering axis parallel to the direction of the vehicle centerline. A tilt toward the rear of the vehicle results in a positive caster angle. During assembly and/or repair of vehicles, it is important to measure, adjust or audit, and set the toe as well as the camber and caster angles of vehicle wheels, and especially steerable wheels, so the vehicle will drive and steer properly

### SUMMARY OF THE INVENTION

The present invention provides an efficient and cost effective way of determining wheel alignment characteristics of a wheel assembly on a vehicle.

According to an aspect of the present invention, a system for determining alignment characteristics of a wheel assembly mounted on a vehicle includes an optical gauge configured to be selectively attached to a wheel assembly, where the optical gauge includes a mounting base having an underside that is affixed to the wheel assembly and includes a gauge piece having a known dimension. The system further includes a light projector configured to project light that is directed onto the optical gauge when attached to the wheel assembly, a digital imager, and a controller. The digital imager is configured to image light from the light projector that is reflected from the optical gauge, with the controller being configured to calculate a distance from the optical gauge based on the imaged light that is reflected from the optical gauge and the known dimension of the gauge piece.

The system further includes a reflector, where the light projector is configured to project light at the reflector and the reflector is configured to direct light at the optical gauge at a known angle, with the controller configured to calculate the distance from the optical gauge further based on the known angle. In a particular embodiment the reflector comprises an adjustable reflector, such as a micro-electro-mechanical system (“MEMS”) whereby the known angle at which the reflector directs light at the optical gauge is changeable and known. In accordance with a further aspect of the present invention, the distance from the optical gauge calculated by the controller comprises a distance from the optical gauge to the digital imager. Still further, the controller is configured to calculate the distance from the optical gauge further based on a known distance from the digital imager to the reflector.

In an embodiment of the optical gauge, the underside of the mounting base may be adhesively mounted to the wheel assembly, where the mounting base may comprise a tape. The known dimension of the gauge piece of the optical gauge comprises a thickness of the gauge piece, and may further comprise a width and/or length of the gauge piece. Still further, the optical gauge may further include a substrate disposed between the gauge piece and the mounting base, where the known dimension of the gauge piece includes a thickness of the gauge piece from a surface of the substrate to an upper surface of the gauge piece. A surface of the gauge piece, such as the upper surface or another surface, may further include a computer readable code, and the digital imager may be configured to image the computer readable code to enable the controller to determine the distance from the optical gauge.

Multiple optical gauges disposed about a wheel assembly may be used to determine multiple distances, such as to one or more digital imagers that are located in a known orientation, whereby a plane may be defined based on the distances, with the plane representing the alignment of the wheel assembly.

A method of determining the alignment characteristics of a wheel assembly using such a system includes affixing one or more optical gauges to a wheel assembly, projecting light from a light projector at a reflector, directing light from the light projector with the reflector at the optical gauges, and imaging light reflected from the optical gauges with a digital imager. The method further includes calculating a distance from the optical gauges with a controller based on the imaged light that is reflected from the optical gauges and the known dimension of the gauge piece and the known angle of the reflector.

According to a further embodiment in accordance with the present invention, a system for determining alignment characteristics of a wheel assembly mounted on a vehicle includes a mounting sheet configured to be selectively attached to a wheel of a wheel assembly, with the mounting sheet including multiple optical gauges disposed thereon that each include a gauge piece comprising a known dimension. The system further includes a light projector configured to project light that is directed onto one or more of the optical gauges when the mounting sheet is attached to the wheel of the wheel assembly, a digital imager, and a controller. The digital imager is configured to image light from the light projector that is reflected from the optical gauge, with the controller configured to calculate a distance from the optical gauge based on the imaged light that is reflected from the optical gauge and the known dimension of the gauge piece. In a further aspect, the system includes a reflector with the light projector configured to project light at the reflector and the reflector is configured to direct light at the optical gauge at a known angle, where the controller is configured to calculate the distance from the optical gauge further based on the known angle.

According to a particular aspect of the embodiment, the mounting sheet includes an underside that is adhesively mounted to the wheel of the wheel assembly, and the mounting sheet may further include a computer readable code. Still further, an applicator machine may be used to apply the mounting sheet to the wheel of a wheel assembly.

A method of determining the alignment characteristics of a wheel assembly using such a system thus comprises affixing a mounting sheet having a plurality of optical gauges to a wheel assembly, projecting light from a light projector at a reflector, directing light from the light projector with the reflector at the optical gauges, imaging light reflected from the optical gauges with a digital imager, and calculating a distance from the optical gauges with a controller based on the imaged light that is reflected from said optical gauge and the known dimension of the gauge piece.

The present invention thus provides a cost effective and efficient system and method for determining the alignment of a wheel assembly mounted to a vehicle. These and other objects, advantages, purposes and features of this invention will become apparent upon review of the following specification in conjunction with the drawings.

### BRIEF DESCRIPTION OF THE DRAWINGS

FIG. 1 is a perspective view of a system in accordance with the present invention for determining the alignment of a wheel assembly of a vehicle;

FIG. 2 is an illustration of the toe angle of a tire and wheel assembly;

FIG. 3 is an illustration of the camber angle of a tire and wheel assembly;

FIG. 4 is a front elevation view of the tire and wheel assembly of the vehicle of FIG. 1 to which optical gauges are affixed;

FIG. 5 is a top plan view of an optical gauge of FIGS. 1 and 4 removed from the tire and wheel assembly;

FIG. 6 is a side elevation view of the optical gauge of FIG. 5;

FIG. 7 is a top plan view of the system shown in relation to the wheel assembly; and

FIG. 8 is a perspective view of a system for determining the alignment of a wheel assembly of a vehicle in accordance with another aspect of the present invention.

### DESCRIPTION OF THE PREFERRED EMBODIMENTS

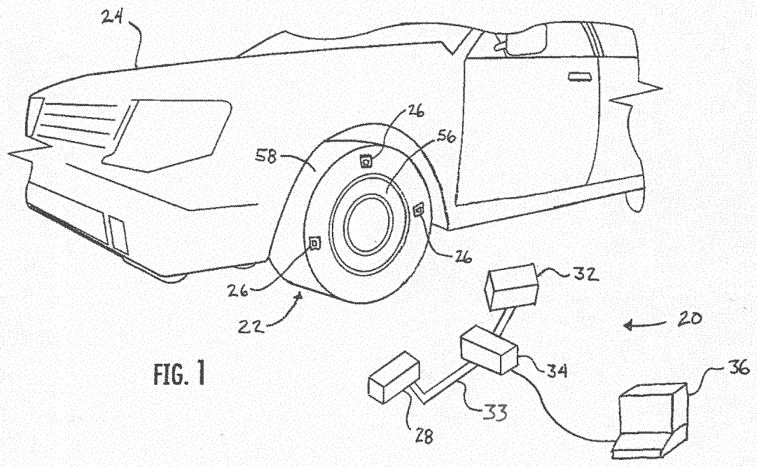

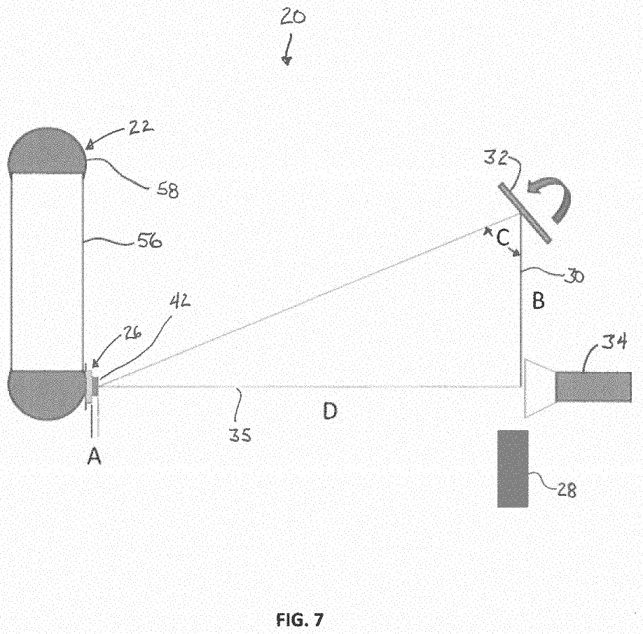

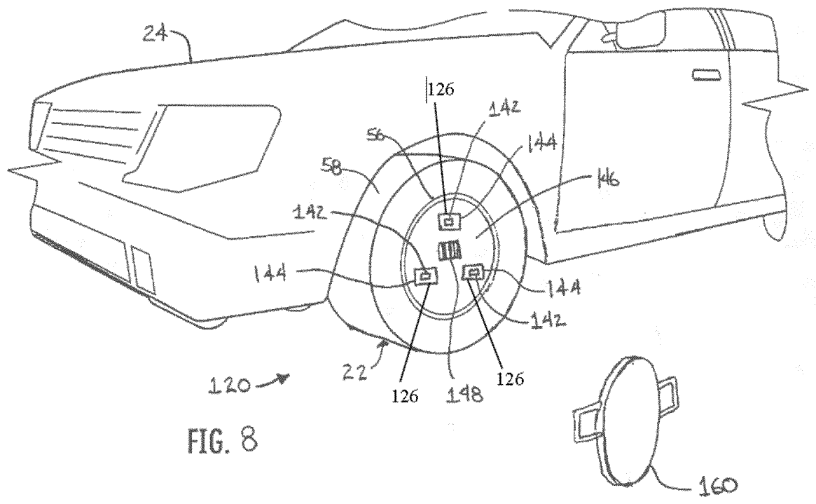

The present invention will now be described with reference to the accompanying figures, wherein the numbered elements in the following written description correspond to like-numbered elements in the figures. A wheel alignment measurement system 20, as shown in the illustrated embodiment of FIG. 1, is used for measuring and/or determining the alignment of a wheel assembly 22 of a vehicle 24, where system 20 includes multiple optical gauges 26 affixed to the wheel assembly 22, a light projector 28 that projects light 30 (FIG. 7) at an adjustable reflector 32 to direct the projected light 30 onto the wheel assembly 22, and a camera or digital imager 34 that images the light 35 reflected off the optical gauges 26 from the projected light 30. In the illustrated embodiment, as discussed in more detail below, the optical gauges 26 have accurately known dimensions and the reflector 32 is configured as a micro-electro-mechanical system (“MEMS”) reflector or mirror such as to enable scanning of the optical gauge 26 on the tire and wheel assembly 22. Based on the known dimensions of the optical gauges 26, as well as the known orientations of the light projector 28 and camera 34 to the reflector 32, and the known angular orientation of the reflector 32, the distance from the tire and wheel assembly 22 to the camera 34 based on the optical gauge 26 can be accurately determined. By determining the distance to multiple optical gauges 26 on the tire and wheel assembly 22, a plane can be determined that represents the three-dimensional orientation of the wheel assembly 22 and thus the alignment of the wheel assembly 22. Moreover, in the illustrated embodiment optical gauges 26 are removably adhesively affixed to each of the tire and wheel assemblies 22 of the vehicle 24, whereby system 20 provides an accurate, efficient and cost effective system for determining the alignment of the wheel assemblies 22.

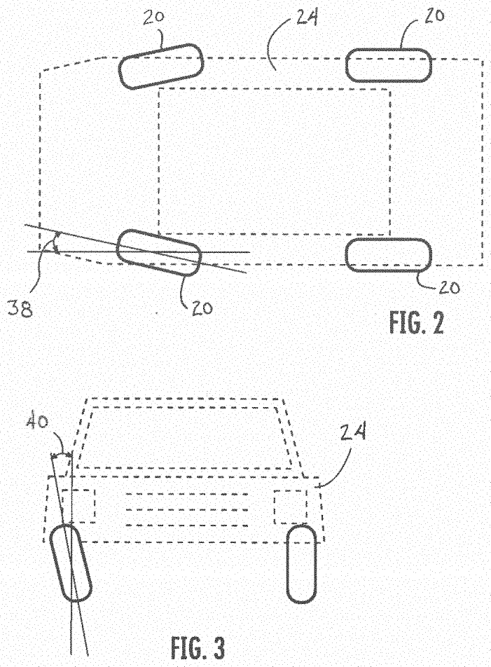

Although system 20 is illustrated in connection with only one wheel assembly 22 in FIG. 1, it should be understood that the system 20 may be used with each of the wheel assemblies 22 of vehicle 24 to which optical gauges 26 are affixed, and that a separate light projector 28, deflector 32 and camera 34 may be used with each wheel assembly 22, and/or that multiple light projectors 28, deflectors 32 and/or cameras 34 may be used at one or all of the wheel assemblies 22 of the vehicle 24. Still further, the light projectors 28, deflectors 32 and cameras 34 may be held together in a known orientation by a frame or fixture 33. As further understood from FIG. 1, system 20 may additionally include one or more computers or controllers 36 for processing of data from the one or more cameras 34 to determine alignment characteristics for the wheel assemblies 22, including, for example, alignment characteristics such as toe angle 38 and camber angle 40, as illustrated in FIGS. 2 and 3, as well as the center of the wheel assembly 22. Still further, determining a plane for each wheel assembly 22 on either side of a vehicle 22 for a given axis may additionally include determining the vehicle centerline or axis of symmetry. For example, employing separate light projectors 28, deflectors 32 and cameras 34 for the wheel assemblies 22 on either side of vehicle 24 may further enable the vehicle centerline or axis of symmetry to be determined.

As understood from FIGS. 5-7, the optical gauges 26 in the illustrated embodiment include a gauge piece 42, a substrate 44 and a mounting base or strip that is configured as an adhesive tape 46 having a mastic underside for removably adhering or sticking to the wheel assembly 22. The gauge piece 42 is constructed to have accurately known dimensions for its height or thickness, where the height or thickness is designated by reference letter “A” in FIGS. 6 and 7, as well as may include accurately known dimensions for its width W and/or length L. Gauge piece 42 additionally includes a code 48 imprinted or affixed to the top surface 50 of gauge piece 42, such as a computer readable code, such as a bar code. As discussed in more detail below, system 20 is able to determine the distance from the wheel assembly 22 to the camera 34 based on the accurately known dimensions of gauge piece 42. Substrate 44 provides a surface for supporting gauge piece 42 and establishing the height A from the top surface 50 of gauge piece 42 to the surface 52 of substrate 44. Tape 46 in turn has an adhesive or mastic underside 54 that is used to secure optical gauge 26 to wheel assembly 22. It should be appreciated that the illustrated embodiments of FIGS. 5 and 6 may not be to scale. That is, for example, the gauge piece 42 may be constructed as a thinner component that is itself a tape like member, or even an alternative member having a different profile. Likewise, substrate 44 may be thinner.

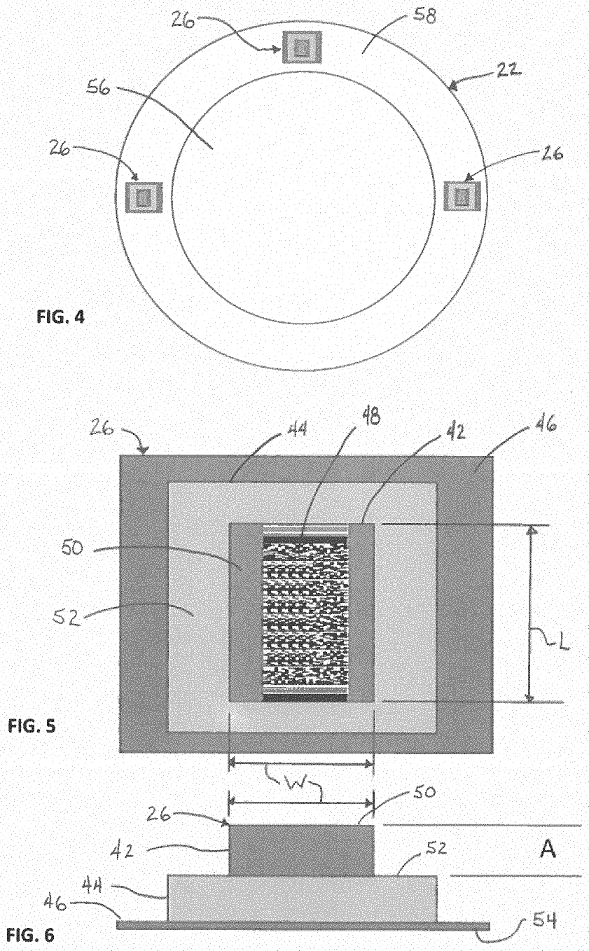

As understood from FIGS. 1 and 4, optical gauges 26 are affixed at various positions about wheel assembly 22, with wheel assembly 22 including both a wheel 56 and tire 58. In the illustrated embodiment three optical gauges 26 are shown affixed about portions of tire 58. Three or more optical gauges 26 may be used in order to define a plane. Placement of the optical gauges 26 is preferably done at or on a common aspect or feature of the wheel assembly 22. For example, as understood from FIGS. 4 and 7, optical gauges 26 are positioned so as to all be disposed at the bulge area of the tire 58. Alternatively, however, the optical gauges 26 may be placed at different locations on the wheel 56 and/or tire 58, such as at a rim feature or otherwise.

The operation of system 20 will now be discussed in more detail with reference to FIG. 7. As there shown, light projector 28, which in the illustrated embodiment is constructed as a laser projector, projects light 30 at reflector 32. Reflector 32 is configured as a MEMS mirror or reflector whereby the angle is adjustably controllable and precisely known. Reflector 32 is thereby able to direct the light onto the wheel assembly 22, and in particular onto the optical gauges 26. In one embodiment, the reflector 32 is operated to adjust the angle of reflection in a raster pattern over the optical gauge 26, such as to thereby scan the optical gauge 26. The reflected light 35 from the optical gauge 26 is then captured by camera 34, which is configured in the illustrated embodiment as an imaging sensor, such as a digital CMOS photosensor array, or the like. The scanning of the optical gauge 26 may be used to form a three dimensional model of the optical gauge 26, and in particular of the gauge piece 42.

Based on the known dimensions of the optical gauges 26, and in particular of the gauge piece 42, as well as the known orientations of the light projector 28 and camera 34 to the reflector 32, and the known angular orientation of the reflector 32, the distance from the tire and wheel assembly 22 to the camera 34 based on the optical gauge 26 can be accurately determined. In particular, as previously noted, the dimension A of the gauge piece 42 of the optical gauge 26 is known very accurately, and the distance B of FIG. 7 from the camera 34 to the reflector 32 is likewise known very accurately, including for temperature changes. As noted, the angle C is adjustable to allow for scanning, with the angle being known very accurately. The distance D is then solved for based on real time observations of A captured by camera 34 to confirm D, which is from the top surface 50 of gauge piece 42. In particular, the distance D is solved for based on trigonometric relationships of the light source 28, camera 34, reflector 32 and optical gauges 26 on wheel assembly 22, along with the known dimension of the optical gauge 26. The distance D is thus the distance from the optical gauge 26, such as from the top surface 50 of gauge piece 42, to the camera 34, and thus represents the distance to the wheel assembly 22.

It should be further appreciated that the real time observations captured by camera 34 may be provided to computer 36 for determination of the distance D, including for each optical gauge located on wheel assembly 22 to thereby determine a plane that represents the three-dimensional orientation of the wheel assembly 22 and thus the alignment of the wheel assembly 22. Moreover, computer 36 may receive the real time observations captured by other cameras 34 at each of the wheel assemblies 22 of vehicle 24. It should be appreciated that for each wheel assembly 22 there may be a single light source 28, reflector 32 and camera 34, or there may be multiple of one or more of these components at each wheel assembly 22.

In a further aspect of the present invention, the noted computer readable code 48 may be used for various aspects related to the process and method for determining alignment. For example, the code 48 may be read, such as via camera 34 and by computer 36, such as via reflected light 35, where the code 48 must first be read prior to enabling the distance D to be solved, where the code 48 may provide confirmation that it is an authentic optical gauge 26 provided for use in connection with system 20, such as provided by the manufacturer of system 20. The code 48 may thus serve as a tool or code to unlock or enable use of the software within computer 36, such as the trigonometric based software code used to solve for D and/or determine the alignment of the wheel assembly 22. Moreover, each optical gauge 26 may have its own unique code that is configured to enable a single use of the optical gauge 26. In this way, for example, a vehicle 22 having four wheel assemblies 22 and utilizing three optical gauges 26 per wheel assembly 22 would use twelve individual optical gauges 26 for use in determining the alignment of each of the wheel assemblies 22 of the vehicle 22. The single use may include, for example, determinations of alignment during an alignment setting process at a vehicle repair shop. Subsequent alignment determinations, such as for another vehicle, may then require the use of new optical gauges 26.

Referring now to FIG. 8, another embodiment of a system 120 for measuring and/or determining the alignment of a wheel assembly 22 of a vehicle 24 is disclosed, where system 120 shares similarities with system 20 with similar features being identified with similar reference numerals, but with “100” added to the reference numerals of system 120. Due to the similarities, not all of the features and functions of system 120 will be discussed herein.

System 120 includes multiple optical gauges 126 supported on a mounting base or sheet 146 that is applied to and over the outer face of the wheel 56 of the wheel assembly 22, where in the illustrated embodiment the mounting base 146 is configured as a larger mastic tape sheet that can be affixed to the wheel 56. In like manner to system 20, a light projector 28 projects light 30 at an adjustable reflector 32 to direct the projected light 30 onto the optical gauges 126, and a camera or digital imager 34 images the light 35 reflected off the optical gauges 26 from the projected light 30 (see FIG. 1). The adhesive mounting sheet 146 thereby functions as both a protective layer to inhibit damage to the wheel 56 of the wheel assembly 22, which is advantageous in that vehicles 24 may often be provided with expensive wheels 56 that are desirably to be protected from damage during repair and/or maintenance operations, as well as functions to place the optical gauges 126 into a controlled orientation for use in determining the alignment orientation of the wheel assembly 22.

In the illustrated embodiment, optical gauges 126 have accurately known dimensions and the reflector 32 is configured as a micro-electro-mechanical system (“MEMS”) reflector or mirror such as to enable scanning of the optical gauges 126 on the wheel 56 of the tire and wheel assembly 22. Optical gauges 126 include a substrate 144 and a gauge piece 142. As with optical gauges 26, based on the known dimensions of the gauge piece 142, as well as the known orientations of the light projector 28 and camera 34 to the reflector 32, and the known angular orientation of the reflector 32, the distance from the tire and wheel assembly 22, and in particular the wheel 56, to the camera 34 based on the optical gauges 126 can be accurately determined. In the illustrated embodiment three optical gauges 126 are disposed on the mounting sheet 146 such that by determining the distance to the multiple optical gauges 126 thereon a plane can be determined that represents the three-dimensional orientation of the wheel 56 and thus the wheel assembly 22, which in turn corresponds to the alignment of the wheel assembly 22. It should be appreciated that an adhesive mounting sheet 146 may be applied to each wheel 56 of the tire and wheel assemblies 22 of vehicle 24, and that more than three optical gauges 126 may be disposed on a given mounting sheet 146. Still further, mounting sheet 146 may include a computer readable code 148 that is imaged by camera 34 and/or read by controller 36 to enable use of the alignment determination software, such as to enable for a single use of the alignment determination software, whereby a new mounting sheet 146 supporting new optical gauges must be used for each wheel assembly 22.

In a particular embodiment a machine or assembly 160 is provided for applying the mounting sheet 146 to the wheel 56 of the wheel assembly 22. In such an embodiment the machine 160 is configured to apply mounting sheets 146 to each wheel 56, where the mounting sheets 146 may be individual mounting sheets 146 or may be a roll of multiple mounting sheets 146. The mounting sheets 146 may include mastic or an adhesive over an entire undersurface or just on portions, such as at or on an outer perimeter portion of the undersurface of mounting sheet 146.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A system for determining alignment characteristics of a wheel assembly mounted on a vehicle, said system comprising:
an optical gauge configured to be selectively attached to a wheel assembly, said optical gauge including a mounting base having an underside that is affixed to the wheel assembly and including a gauge piece comprising a known dimension;
a light projector configured to project light that is directed onto the optical gauge when attached to the wheel assembly;
a digital imager; and
a controller;
wherein said digital imager is configured to image light from the light projector that is reflected from the optical gauge, and wherein said controller is configured to calculate a distance from said optical gauge based on the imaged light that is reflected from said optical gauge and said known dimension of said gauge piece.

2. The system of claim 1, further including a reflector, and wherein said light projector is configured to project light at said reflector and said reflector is configured to direct light at said optical gauge at a known angle, and wherein said controller is configured to calculate said distance from said optical gauge further based on said known angle.

3. The system of claim 2, wherein said reflector comprises an adjustable reflector whereby said known angle at which said reflector directs light at said optical gauge is changeable and known.

4. The system of claim 3, wherein said adjustable reflector comprises a micro-electro-mechanical system.

5. The system of claim 1, wherein said distance from said optical gauge calculated by said controller comprises a distance from said optical gauge to said digital imager.

6. The system of claim 1, wherein said underside of said mounting base is adhesively mounted to the wheel assembly.

7. The system of claim 6, wherein said mounting base comprises a tape.

8. The system of claim 1, wherein said known dimension of said gauge piece comprises a thickness of said gauge piece.

9. The system of claim 1, wherein said known dimension of said gauge piece comprises a width and/or length of said gauge piece.

10. The system of claim 1, wherein said gauge piece further includes a substrate disposed between said gauge piece and said mounting base, and wherein said known dimension of said gauge piece comprises a thickness of said gauge piece from a surface of said substrate to an upper surface of said gauge piece.

11. The system of claim 2, wherein a distance from said digital imager to said reflector is known, and wherein said controller is configured to calculate said distance from said optical gauge further based on said distance from said digital imager to said reflector.

12. The system of claim 1, wherein said gauge piece includes an upper surface and wherein said upper surface includes a computer readable code.

13. The system of claim 12, wherein said digital imager is configured to image said computer readable code to enable said controller to determine said distance from said optical gauge.

14. A system for determining alignment characteristics of a wheel assembly mounted on a vehicle, said system comprising:
a plurality of optical gauges configured to be selectively attached to a wheel assembly, said optical gauges each including a mounting base comprising a tape and having an underside that is adhesively affixed to the wheel assembly and including a gauge piece comprising a known dimension;
at least one light projector configured to project light that is directed onto the optical gauges when attached to the wheel assembly;
at least one digital imager; and
a controller;
wherein said at least one digital imager is configured to image light from the at least one light projector that is reflected from the optical gauges, and wherein said controller is configured to calculate distances from said optical gauges based on the imaged light that is reflected from said optical gauge and said known dimension of said gauge pieces, and wherein said controller is configured to determine a plane based on said distances from each of said optical gauges, and wherein said distances from said optical gauges calculated by said controller comprises distances from said optical gauges to said at least one digital imagers; and
further including at least one reflector, and wherein said at least one light projector is configured to project light at said at least one reflector and said at least one reflector is configured to direct light at said optical gauges at a known angle, and wherein said controller is configured to calculate said distances from said optical gauges further based on said known angles, and wherein said at least one reflector comprises an adjustable reflector whereby said known angle at which said reflector directs light at said optical gauges is changeable and known.

15. The system of claim 14, wherein said known dimension of said gauge pieces comprises a thickness of said gauge pieces.

16. The system of claim 15, wherein said gauge pieces further include a substrate disposed between said gauge pieces and said mounting bases, and wherein said known dimension of said gauge pieces comprises a thickness of said gauge pieces from a surface of said substrates to an upper surface of said gauge pieces.

17. The system of claim 14, wherein a distance from said digital imager to said reflector is known, and wherein said controller is configured to calculate said distance from said optical gauge further based on said distance from said digital imager to said reflector.

18. The system of claim 14, wherein said gauge piece includes an upper surface and wherein said upper surface includes a computer readable code.

19. The system of claim 18, wherein said digital imager is configured to image said computer readable code to enable said controller to determine said distance from said optical gauge.

20. A system for determining alignment characteristics of a wheel assembly mounted on a vehicle, said system comprising:
a mounting sheet configured to be selectively attached to a wheel of a wheel assembly, said mounting sheet including a plurality of optical gauges disposed thereon, said optical gauges each including a gauge piece comprising a known dimension, wherein said mounting sheet includes an underside, and wherein said underside of said mounting sheet is adhesively mounted to the wheel of the wheel assembly;
a light projector configured to project light that is directed onto one or more of the optical gauges when said mounting sheet is attached to the wheel of the wheel assembly;
a digital imager; and
a controller;
wherein said digital imager is configured to image light from the light projector that is reflected from the optical gauge, and wherein said controller is configured to calculate a distance from said optical gauge based on the imaged light that is reflected from said optical gauge and said known dimension of said gauge piece.

21. The system of claim 20, further including a reflector, and wherein said light projector is configured to project light at said reflector and said reflector is configured to direct light at said optical gauge at a known angle, and wherein said controller is configured to calculate said distance from said optical gauge further based on said known angle, and wherein said reflector comprises an adjustable reflector whereby said known angle at which said reflector directs light at said optical gauge is changeable and known.

22. The system of any of claim 21, wherein said distance from said optical gauge calculated by said controller comprises a distance from said optical gauge to said digital imager.

23. The system of claim 20, wherein said mounting sheet includes a computer readable code.
